(19) United States
(12) Patent Application Publication
(10) Pub. No.: US 2008/0108023 A1
(43) Pub. Date: May 8, 2008

(54) Visual communication device

(76) Inventor: Shelton Partee, St. Louis, MO (US)

Correspondence Address: HAVERSTOCK, GARRETT & ROBERTS LLP, 611 OLIVE STREET, SUITE 1610, ST. LOUIS, MO, 63101, US

(21) Appl. No.: 11/543,556

(22) Filed: Oct. 5, 2006

(51) Int. Cl. G09B 21/00

(52) U.S. Cl. 434/112

(57) ABSTRACT

A manual communication system is disclosed for effectively communicating with a voice disabled and physically impaired person who is enabled to communicate using merely limited gestures as triggers such as by the use of blinking eyes for YES or NO and use of placards for instruction and a means for spelling out words in response to the yes/no gesture.

### BACKGROUND OF THE INVENTION

The present invention relates to communications systems, particularly systems for communicating with voice-impaired patients who may also be incapable of effectively communicating, due to other motor paralyses.

### BACKGROUND OF THE PRIOR ART

Various types of communication devices have been developed to aid communication with voice-impaired persons. Most, however, are directed to assisting in providing sound of some sort. Patients who have been assisted with these sorts of systems and devices have been those impaired with, for example, multiple sclerosis, post-operative problems and conditions such as being hypotonic, being intubated, or patients who are surdimutic or who have other voice disabilities. Prior art systems have attempted to designate, identify, or communicate the basic needs of a patient by employing tools such as color, symbols, pictures, phrases, etc. to enable communication of the patient's wants, needs, or other status. Most of the prior art systems employ electronic communication means such as computers, keyboards, lights, horns, or buzzers to communicate.

However, most of said devices have a shortcoming. Such devices and/or systems assume or require that the voice-impaired person have numerous motor skills to implement the communication system. Some of these systems are, for example disclosed in U.S. Pat. Nos. 4,165,890; 4,761,633; 4,954,083; 6,422,875; 4,503,426; and 5,910,009.

It would be a substantial advancement in the art and a fulfillment of a long-felt need if there were a communications system for voice-impaired persons who also lacked motor skills other than use of the eyes or other simple gesture which would signal merely YES or NO.

### SUMMARY OF THE INVENTION

The principal object of the instant invention is to provide an efficient procedural system/technique for manipulation of a menu of the alphabet and numbers, by triggers or signals that communicate simple absolutes such as YES or NO, for disabled, voice-impaired people.

The invention comprises a communication procedure kit where there are displays combining written words and/or numbers to enable communication from the voice-impaired person.

This is an interactive low tech therapeutic system. The kit can be used by a person with voice disabilities to quickly enter one letter of the alphabet or one number at a time as required to spell out words and communicate expressions.

This system can be used in daily living, can be used to designate and/or communicate in a basic fundamental manner, thus fostering self-sufficiency.

### BRIEF DESCRIPTION OF THE DRAWINGS

FIG. 1 is an illustration of the first placard (or Placard 10) of my invention and is known as the notice board;

FIG. 2 is an illustration of the second placard (or Placard 20) of my invention and is known as the communication board;

FIG. 3 is an illustration of a tripod holding the second placard and an erasable board member;

FIG. 4 illustrates a tripod stand having the second placard of my invention and an alternative embodiment of a chalkboard as the erasable board member of my invention.

### DETAILED DESCRIPTION AND THE PREFERRED EMBODIMENTS

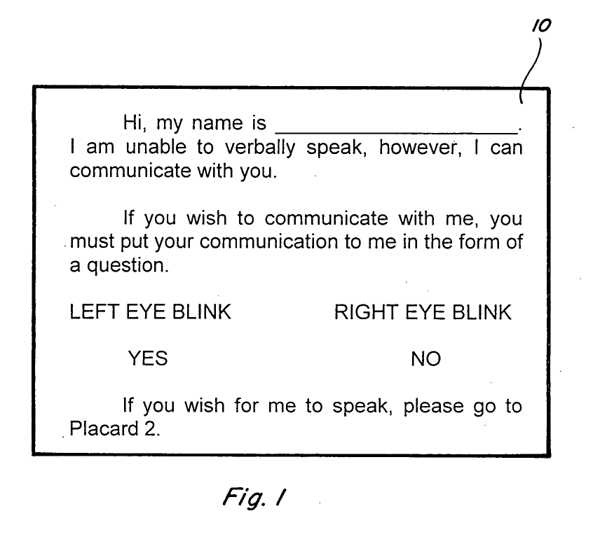

Referring to FIG. 1, the first Placard 10, of this invention is shown, and referred to as System Notice Board (S.N.B.)

The first Placard 10 contains a written introduction of the patient and a notice as to how the patient will communicate or trigger “YES” or “NO”. For a paralyzed, or partially paralyzed person or a patient who is hypotonic, surdimutic, intubated, or with other voice deficient limitations the notice will indicate how to talk to the patient, and what the patient will do to trigger “YES” and “NO” and other instructions. To facilitate conversation with the voice-disabled person, whose cogitative skills are operative, but whose motor skills are severely limited, the type of trigger will depend to a large extent on the type of disability suffered by the patient. For example, blinking the eyes can be a trigger.

The size of the first Placard 10 may be determined by whatever size carrying case is desired for the kit. The first Placard can be foldable.

Preferably the first Placard 10 has a white background and black letters/numbers. Placard 10 is preferably placed in a conspicuous place near the bed or seat for the impaired person/patient.

Different patients will have different abilities to give a signal/trigger to activate the absolute YES or NO. Whatever signal the voice-impaired person can use best, should be the trigger.

The first Placard 10 also instructs the reader who desires to communicate with the patient, to go to Placard 20.

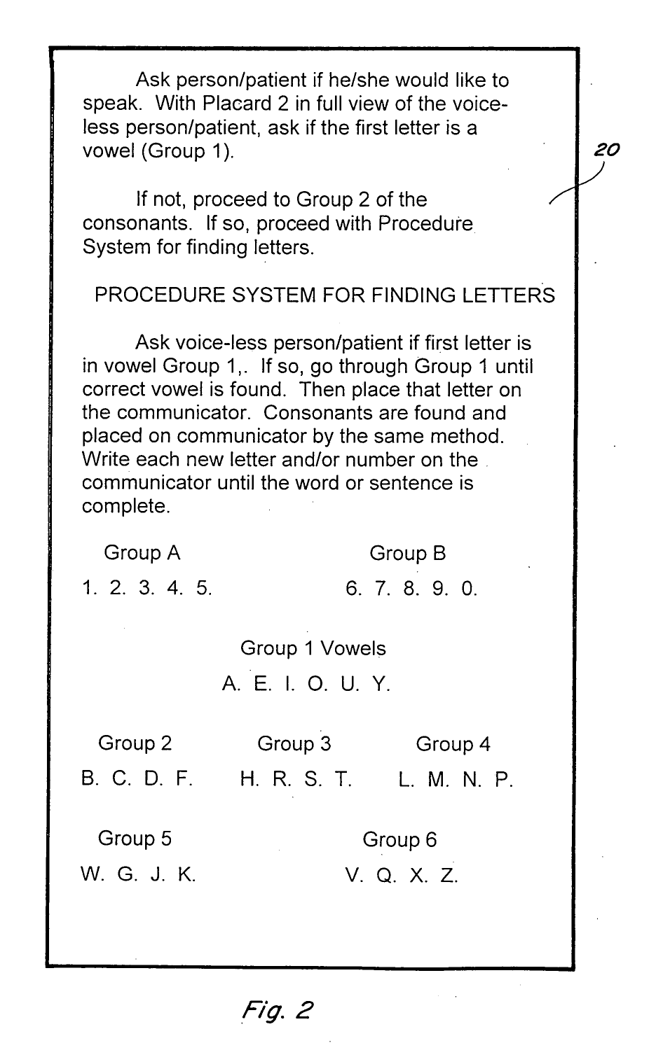

In accordance with the invention and as illustrated in FIG. 2, Placard 20 may be referred to as the Communication Procedure Board (C.P.B.).

The size of Placard 20 (C.P.B) also depends upon whatever the size carrying case is desired for the kit. Placard 20 can be foldable, so long as it fits in the carrying case and allows fitting of a tripod/stand 30, to display Placard 10 and 20.

It is preferred that Placard 20 be white background and black letters or numbers.

Placard 20 may be conspicuously placed on tripod or stand 30 where the patient and person communicating can readily see the system.

Letters and numbers preferably should be of a size that a person standing ten (10) feet away can see and readily identify them easily.

The second Placard 20 is the heart of the system. This Placard contains the instructions for communicating with the impaired who is thereby enable to respond to questions. The impaired person who may have previously felt alone and isolated is now able to respond to friends, family, and loved ones who visit and who desire to communicate. The system is quickly learned and the experience is profound!

As shown in the drawings for purpose of illustration, FIGS. 1 and 2 of the present invention are concerned with the devices for communicating with a voice-disabled person, whose cogitative skills are operative, but whose motor skills are severely limited, or even paralyzed.

In accordance with the invention, and as illustrated in FIG. 2, the Placard 20 contains three paragraphs and a grouping of the numerals 0 through 9 in two groups, and the letters of the alphabet arranged into six (6) groups. Although FIGS. 1 and 2 are in English and use Arabic numbers, any language or any numeric system could be used.

The bulk of the processing of the system is by a party other than the patient. That person or communicator makes the selections and writes out each word, character-by-character, to form sentences and statements, which can be approved or disapproved by the patient.

The first three paragraphs serve to instruct users of the system to inquire if the impaired person would like to speak. The patient will respond in accordance with the mode or trigger identified on Placard 10.

The patient is asked to communicate letter-by-letter or character-by-character, by first asking group-by-group, in which grouping of characters may the characters be found.

The system user moves from VOWEL selection to CONSONANT selection to NUMBERS, in whatever order is desired, but communication will be more effective if a consistent pattern is followed.

In order to expedite selection, we refer to Selection Menu being the English Alphabet, by the noted groupings.

The arrangement of the English Alphabet, as stated, creates a menu, where selections are made. Foremost, as demonstrated on Placard 20, are the grouping of the Vowels Group (1), see FIG. 2.

Group (1) Vowels
A. E. I. O. U. Y.

The vowels are Group (1). As shown, Placard 20, first paragraph, asking the impaired person if he/she would like to speak, brings into play FIG. 2, third paragraph. A preferred operation of the system allows that the first question to the impaired person, may be “is the first letter a vowel?”. Then, “is the next letter a vowel?” This may be asked after every placement of a selection from the selection menu. When appropriate, one can ask, “is that the end of the word?” Or perhaps, one can ask “is that the end of the sentence?”

Consonants are preferably selected and grouped as a function of their frequency of recurrence in common spelling. Consonants, as in FIG. 2 are grouped according to frequency of use in the following quickly accessible menus:

| | | |
|---|---|---|
| Group (2) Consonants | | Group (3) Consonants |
| B. C. D. F. | | H. R. S. T. |
| | Group (4) Consonants | |
| | L. M. N. P. | |
| Group (5) Consonants | | Group (6) Consonants |
| W. G. J. K. | | V. Q. X. Z. |

Further, FIG. 2, Placard 20 creates a selection menu for numbers, grouped into two groups, i.e. Groups (A) and (B).

| Group (A) Numbers | Group (B) Numbers |
|---|---|
| 1. 2. 3. 4. 5. | 6. 7. 8. 9. 0. |

The procedure for the communicator selecting the numbers desired by the patient is the same as the procedure for selecting the letters, i.e., by process of elimination.

Placard 20/FIG. 2 gives instructions for using the trigger identified on Placard 01/FIG. 1 when inquiring if the voice-impaired patient would like to speak.

The trigger can be blinking an eye or eyes, a person's finger, moving a hand, twitching a foot, raising an elbow, or other body parts, so that the trigger can be operated by different person having any variation of severe physical limitations.

Placard 20/FIG. 2 gives instructions using the same trigger as on Placard 10/FIG. 1, best for letters of the alphabet for the Selection Menu of numbers.

If the first letter is not a vowel, proceed to Group 2 of the Consonants and ask is it in Group 2?, is it in Group 3 or 4, etc?

Once the Group number has been identified, the correct letter can be identified by process of elimination. That is beginning with the first letter in that group, ask the impaired person if each letter is correct until the patient triggers YES.

The process may be repeated as often as necessary.

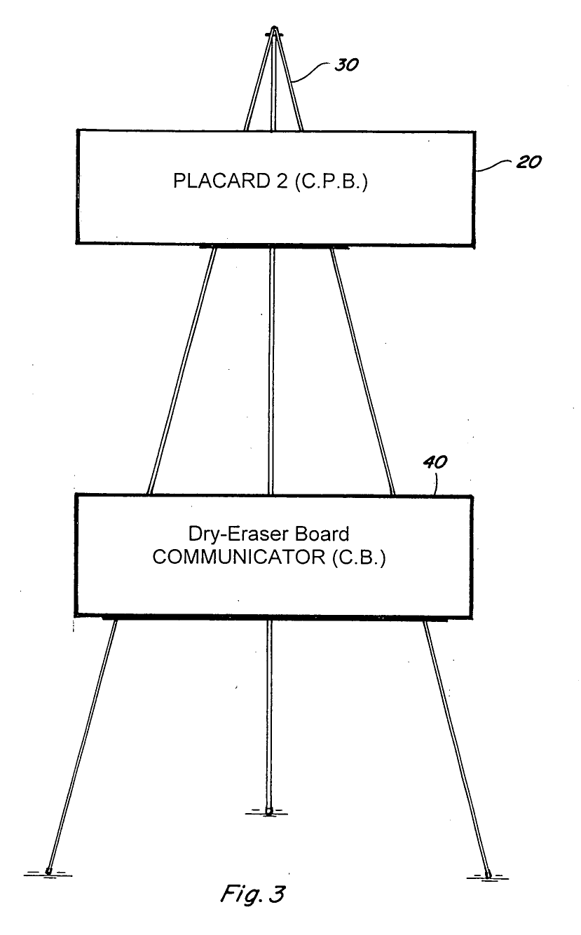

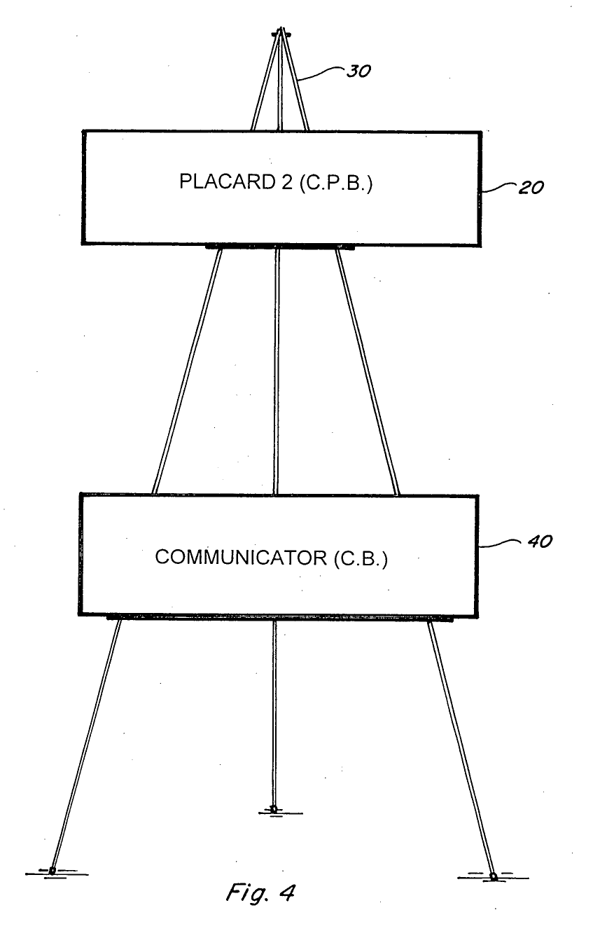

The devices of this invention, as demonstrated in FIGS. 1, 2, 3 and 4, contain the paraphernalia of this kit, which comprises: a tripod or stand 30 to hold the Placards 10 and 20, a dry erase board 40, a dry marker, associated with the board, a dry eraser; a writing pad, pen or pencil, or other device for displaying words which evolve, such as a keyboard screen or other display device is used to display words or sentences as they evolve from the patient one letter at a time.

Although the technique disclosed herein have been specifically adapted and illustrated, it should be understood that the system could be adapted to other triggers and modus operandi, all of which are well within the contemplation and scope of the invention.

What is claimed is:

1. A communications system comprising:
a. a first placard for displaying a notice of a patient's physical impairment and for providing other notices germane to a patient's condition including describing how the patient will trigger a YES or NO response, and
b. a second placard for communicating directly with the impaired patient, said placard having displayed thereon in a movable and removable fashion a numeric scheme divided into groups of different numbers and said second placard further comprising a scheme of an alphabet have groups of different letters; and
c. a display device such as a pencil and pad, or keyboard and screen or erasable ink and board, for selecting and organizing said numerals and letters of the alphabet into expressions in response to triggers of the patient.

2. The system of claim 1 wherein the placards are provided with a stand or tripod.

3. The system of claim 1 wherein the placards are dry eraser boards.

4. The system of claim 1 wherein the device for displaying the communications of claim 1 are with an erasable ink or chalk or other erasable writing tool.

5. The system of claim 1 wherein the communication trigger is the patient blinking an eye.
